(19) United States
(12) Patent Application Publication
(10) Pub. No.: US 2006/0232958 A1
(43) Pub. Date: Oct. 19, 2006

(54) Flameless taper candle

(76) Inventor: Ming-Huang Chang, Dongguan (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/104,459

(22) Filed: Apr. 13, 2005

(51) Int. Cl. F21L 4/00

(52) U.S. Cl. 362/190

(57) ABSTRACT

A flameless taper candle provides a wax sleeve with an attractive shape that is easily manufactured, and includes an elongated portion, a light portion, a power portion, a wax sleeve, and a switch portion. The elongated portion has an upper tubular body and a PCB assembled in the upper tubular body. The PCB has a flicker IC. The light portion has a lamp exposed outside the upper tubular body, and a lampshade covering the lamp. The power portion has a lower tubular body and at least one rechargeable battery. The lower tubular body is secured to the upper tubular body. The rechargeable battery is disposed in the lower tubular body and electrically connecting with the PCB. The wax sleeve covers the upper tubular body and the lower tubular body. The switch portion is secured on an end of the lower tubular body for controlling the lamp.

### BACKGROUND OF THE INVENTION

1. Field of the Invention

The present invention relates in general to a flameless taper candle, which is an electrical candle using an electrical lamp without flame to replace traditional candle.

2. Description of the Prior Art

It is usually to celebrate festival or decorate windows with candles during the holidays as Christmas, Hanukkah, Halloween, and so on. Nowadays, the traditional wax candles are replaced with electric candles available and sold in abundant variety.

Electrical candles are usually designed to install on a window sill or held in hands. However, now available electrical candles usually have a monotone cylinder shape, which is short of variation and attraction. Besides, the casing of the electrical candle is usually made of plastic and looks very false, which causes some people to not appreciate the electrical candle. Moreover, the holders for holding a bottom part of the electrical candle usually has different sizes, and the electrical candles usually cannot adapt to all holders, which makes the electrical candles lacks of flexibility.

The present invention is a substantial improvement and alleviates the disadvantages and deficiencies of the prior art.

### SUMMARY OF THE INVENTION

An objective of the present invention is to provide a flameless taper candle covered with an easily-manufactured wax sleeve, which makes the flameless taper candle being almost real and can provides various appearances full of attraction.

Another objective of the present invention is to provide a flameless taper candle, which is flexibly used in different occasions, for instance, can be held in outdoor occasions or fixed in holders in indoor occasions.

Another objective of the present invention is to provide a flameless taper candle, which is able to adapt to different sizes of holders.

In order to achieve the above objectives, the present invention provides a flameless taper candle including an elongated portion, a light portion, a power portion, a wax sleeve, and a switch portion. The elongated portion has an upper tubular body and a PCB. The upper tubular body is taper-shaped and has a top portion and an end portion. The PCB has a flicker IC and is assembled in the upper tubular body. The light portion has a lamp and a lampshade. The lamp is electrically connecting with the PCB and is exposed outside the top portion of the upper tubular body. The lampshade is fixed on the top portion of the upper tubular body and covers the lamp. The power portion has a lower tubular body and at least one rechargeable battery. The lower tubular body is taper-shaped, and has a top portion and an end portion. The top portion of the lower tubular body is removably secured to the end portion of the upper tubular body. The at least one rechargeable battery is disposed in the lower tubular body and electrically connecting with the PCB. The wax sleeve has an inner shell and a wax layer coated on the inner shell, and defines a taper-shaped cavity for receiving the upper tubular body and the lower tubular body. The switch portion is removably secured on the end portion of the lower tubular body for interrupting or connecting the rechargeable battery to the PCB, and has a recharge jack mounted therein.

### BRIEF DESCRIPTION OF THE DRAWINGS

The invention will be better understood and objectives other than those set forth above will become apparent when consideration is given to the following detailed description thereof. Such description makes reference to the attached drawings, wherein:

FIG. 1 is an exploded cross-sectional view of a flameless taper candle according to the present invention;

FIG. 2 is a partial exploded cross-sectional view of a flameless taper candle according to the present invention;

FIG. 2A is a top view of a bottom jacket of a flameless taper candle according to the present invention;

FIG. 3 is an assembled cross-sectional view of a flameless taper candle according to the present invention;

FIG. 4 is a perspective view of a decorative candleholder with a plurality of flameless taper candle of the present invention;

FIG. 5 is a perspective view of a flameless candle of another embodiment according to the present invention; and

FIG. 6A to 6F are front views of flameless candles respectively covered with a different wax sleeve according to the present invention.

### DETAILED DESCRIPTION OF PREFERRED EMBODIMENTS

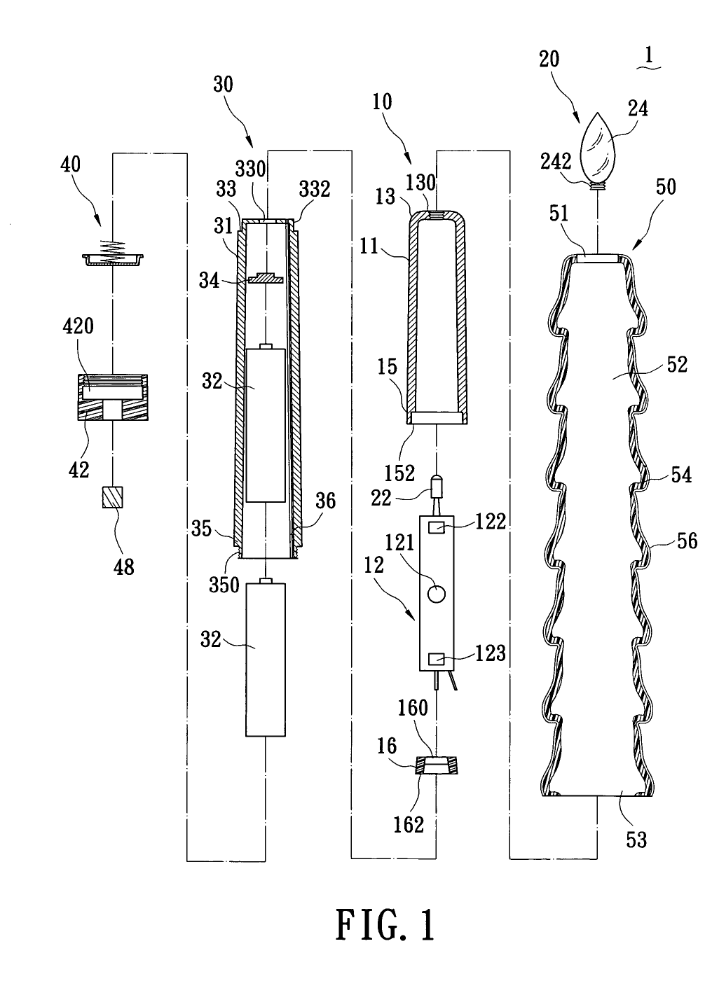

Please refer to FIG. 1, which is an exploded cross-sectional view of a flameless taper candle according to the present invention. The present invention provides a flameless taper candle 1, which includes an elongated portion 10, a light portion 20, a power portion 30, a switch portion 40, and a wax sleeve 50.

The elongated portion 10 has an upper tubular body 11 and a PCB (printed circuit board) 12. The upper tubular body 11 is taper-shaped and is preferably made of insulative material, such as plastic. The upper tubular body 11 has a top portion 13 and an end portion 15. The PCB 12 is assembled in the upper tubular body 11 and has a flicker IC (integrated circuit) 121 mounted thereon. The flicker IC 121 can produce a flickering effect like a real flame, but without a hazardous flame. The PCB 12 can further include other IC, such as a photocell IC 122 for controlling light automatically at night, and a timer IC 123 for providing a time-control function and lighting in predetermined hours. In a preferred embodiment, the photocell IC 122 can be mounted at a top portion of the PCB 12 adjacent to a top portion of the wax sleeve 50 for sensing light. The timer IC 123 can turn off after a period of time, such as 4 hours, so that it can economize electricity power and prolong an using life of batteries. In this embodiment, the present invention further includes a fixing element 16, which is mounted in the upper tubular body 11 for fixing the PCB 12. The fixing element 16 can be made of plastic and is flexible, so that it can interfere with an inner wall of the upper tubular body 11 and is fixed for holding the PCB 12. In this embodiment, the fixing element 16 has an annular ring 162 and is formed with a central hole 160. The annular ring 162 can interfere with the inner wall of the upper tubular body 11. The central hole 160 allows wires to pass through the fixing element 16 for electrically connecting to the PCB 12.

The light portion 20 has a lamp 22 and a lampshade 24. In this embodiment, the lamp 22 is a LED (Light Emitting Diode) and is soldered on a top of the PCB 12. The lamp 22 is electrically connecting with the PCB 12 and is exposed outside the top portion 13 of the upper tubular body 11. The lampshade 24 is fixed on the top portion 13 of the upper tubular body 11 and covers the lamp 22. For instance, screw the lampshade 24 into the top portion 13 of the upper tubular body 11. For this purpose, the top portion 13 is formed with a female thread portion 130, and the lampshade 24 is formed with a male thread portion 242 for securing with the female thread portion 130 of the upper tubular body 11.

The power portion 30 has a lower tubular body 31 and at least one rechargeable battery 32. The lower tubular body 31 substantially is taper-shaped and is preferably made of insulative material, such as plastic. The lower tubular body 31 has a top portion 33 and an end portion 35. The top portion 33 of the lower tubular body 31 is removably secured to the end portion 15 of the upper tubular body 11. For this purpose, in this embodiment, the end portion 15 is formed with an engaged cavity 152, and the top portion 33 of the lower tubular body 31 is formed with an engaged protrusion 332 for engaging within the engaged cavity 152. This embodiment includes two AA-type or AAA-type rechargeable batteries 32 disposed in the lower tubular body 31. The rechargeable batteries 32 are electrically connecting with the PCB 12. However, the rechargeable battery is not limited in AA-type or AAA-type.

The lower tubular body 31 has a conductive rivet 34 and a conductive lead 36. The conductive rivet 34 is fixed on the top portion 33 of the lower tubular body 31. In this embodiment, the top portion 33 is formed with a through hole 330 for exposing out the conductive rivet 34 to contact with the rechargeable battery 32. The conductive lead 36 is fixed on an inner surface of the lower tubular body 31. The conductive rivet 34 is electrically connecting with the PCB 12 and a positive electrode of the rechargeable battery 32. The conductive lead 36 is electrically connecting with the PCB 12 and the switch portion 40.

The wax sleeve 50 has an inner shell 54 and a wax layer 56 that is coated on the inner shell 54, and defines a taper-shaped cavity 52 for receiving the upper tubular body 10 and the lower tubular body 30 therein. The material of the inner shell 54 could be plastic, such as thermoplastic or thermosetting plastic. The preferred material in this present invention is vinyl plastic or ployresin. A centrifugal casting molding technology can form the inner shell made of vinyl plastic. The centrifugal casting molding technology includes following steps: casting vinyl plastic into a mold, centrifugally rotating the mold, heating the mold by oil-fired furnace, drawing out the shaped inner shell, and cooling down the inner shell. The vinyl plastic mold used in the centrifugal casting molding technology is cheaper, and is easy to change and make a new shape. The vinyl plastic also has a characteristic of being easily coated with wax on an outside surface thereof.

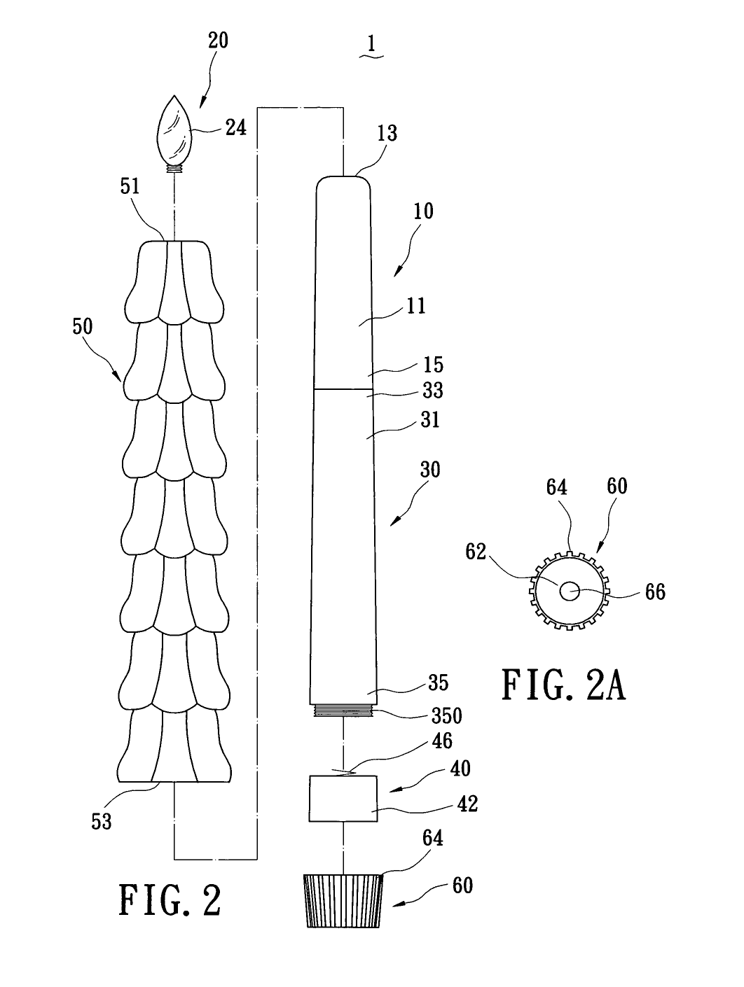

The taper-shaped cavity 52 matches with the shape of the upper tubular body 11 and the lower tubular body 31. A top opening 51 and an end opening 53 are formed on a top end and a lower end of the wax sleeve 50, respectively. After assembling the elongated portion 10 with the lower portion 30, cover the wax sleeve 50 on the upper tubular body 11 and the lower tubular body 31 from up and down, as shown in FIG. 2. Then screw the lampshade 24 to the elongated portion 10. The end opening 53 of the wax sleeve 50 is aligned to the end portion 35 of the lower portion 30.

The switch portion 40 is removably secured on the end portion 35 of the lower tubular body 31 for turning on or off the lamp 22, i.e. interrupting or connecting the rechargeable battery 32 to the PCB 12. The switch portion 40 has an insulative cap 42, a metal plate 44, and a spring 46. The insulative cap 42 is formed with a female thread portion and the end portion 35 of the lower tubular body 31 is formed with a male thread portion 350 for screwing with the insulative cap 42. The insulative cap 42 is formed with a cavity 420 for receiving the metal plate 44. The spring 46 is fixed on the metal plate 44 and is electrically connecting with a negative electrode of the rechargeable battery 32. The switch portion 40 has a recharge jack 48 mounted in the insulative cap 42 for connecting with a recharge plug.

The flameless taper candle of the present invention can be applied in different special occasions, and can be usually fixed on a candleholder or a candelabrum. To adapt to different sizes of candleholders, the flameless taper candle 1 further comprises a bottom jacket 60, as shown in FIGS. 2 and 2A. The bottom jacket 60 is formed with a cap cavity 62 for receiving the insulative cap 42 and covers a periphery of the insulative cap 42. The bottom jacket 60 has a plurality of flexible ribs 64 which are extending outwardly from a periphery thereof.

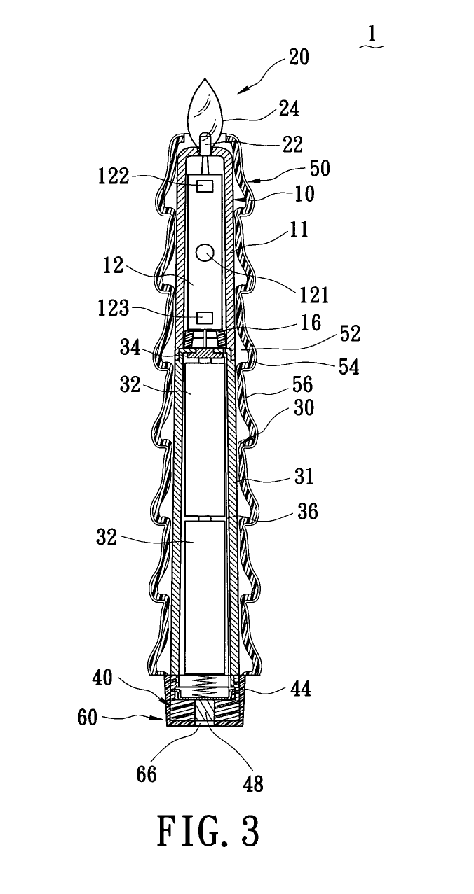

Reference is made in FIG. 3, which is an assembled cross-sectional view of a flameless taper candle of the present invention. The flameless taper candle 1 can be held conveniently in hand. People can enjoy the peaceful, calming, soothing glow of a candle without the flame, soot and dripping wax with the battery powered flickering flameless candle. The flameless taper candle 1 is covered with the wax sleeve 50, so that it looks like a true tradition candle. The switch portion 40 is mounted under each of the flameless taper candle 1 that allows user to easily turn the candle on or off. The flameless taper candle 1 will glow for many hours before the rechargeable batteries 32 need to be changed. Unlike traditional candles, the flickering flameless taper candle 1 will never burn down, melt away, and never need replacing. The recharge jack 48 mounted in the insulative cap 42 allows user recharge the rechargeable battery 32 easily by connecting with the recharge plug.

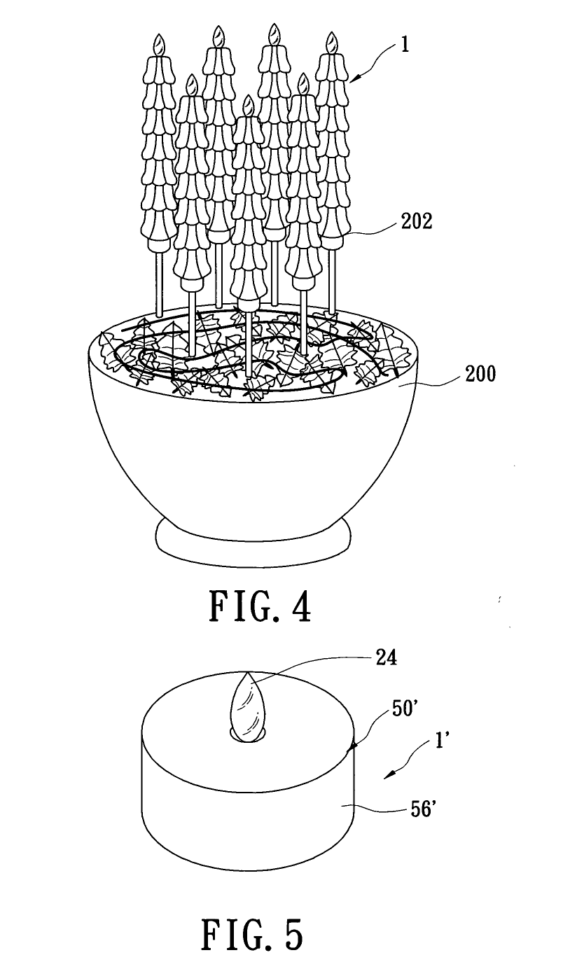

Reference is made in FIG. 4, which is a perspective view of a decorative candleholder with a plurality of flameless taper candle according to the present invention. A decorative candleholder 200 has many holders 202. The plural flexible ribs 64 of the bottom jacket 60 make the present invention able to adapt to different sizes of holders 202 flexibly. In this embodiment, the bottom jacket 60 is formed with a plugging hole 66 in a central bottom portion thereof. Each of the holders 202 can connect with an electrical power and provides a recharge plug, which can be treated as a recharging seat to recharge the rechargeable batteries 32. The plugging hole 66 of the bottom jacket 60 allows the recharge plug passes and plugs into the recharge jack 48.

Reference is made in FIG. 5, which is a perspective view of a flameless candle of another embodiment according to the present invention. Although the above-mentioned structure of the present invention is applied in the taper candle, the present invention also can be applied in other shape, such as a votive candle 1′ as shown in FIG. 5. The votive candle 1′ usually has a size of 2″×1.75″, which can be covered with a wax sleeve 50′ according to the present invention described above. The wax sleeve 56′ has a wax layer 56′, and the wax layer 56′ can be shaped variously, such as a lotus shape, or a fruit shape . . . etc. The votive candle 1′ can use a button-type battery for economizing space.

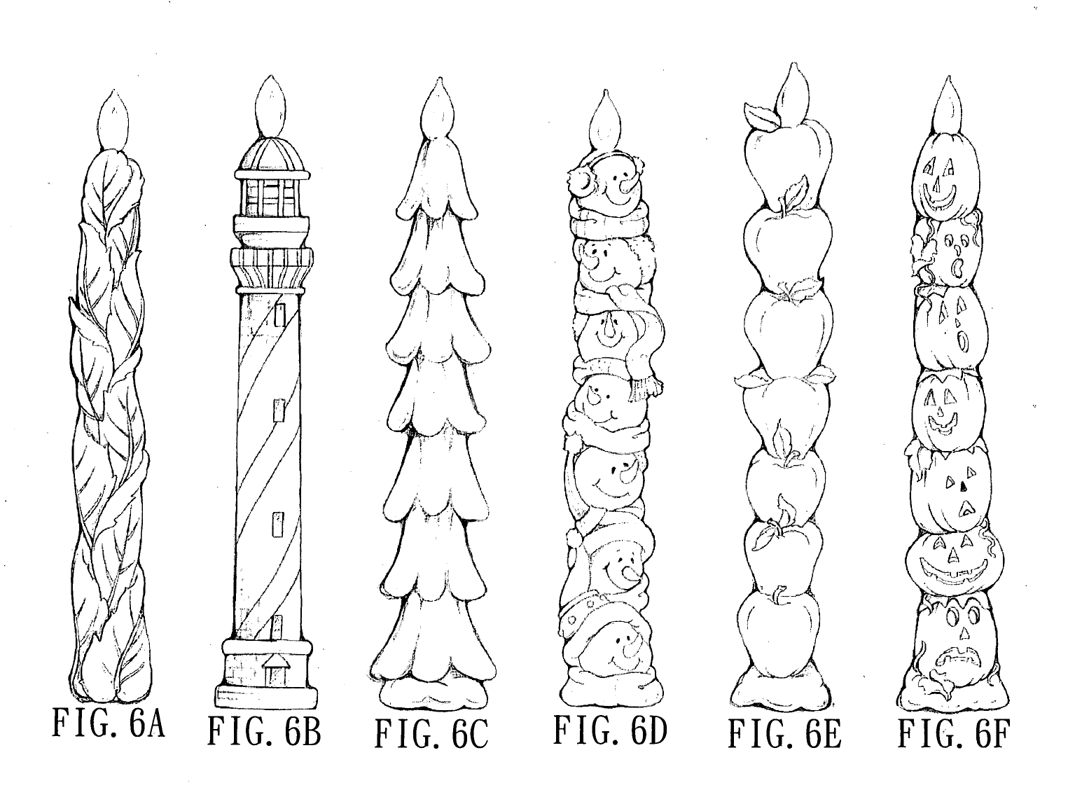

References are made in FIG. 6A to 6F, which are perspective views of a flameless candle covered with different wax sleeves according to the present invention. The flameless candles are covered respectively with the unique wax sleeves, which provides different attractive shapes, such as leaves shown in FIG. 6A, a light house shown in FIG. 6B, Christmas trees shown in FIG. 6C, snowmen shown in FIG. 6D, apples shown in FIG. 6E, or pumpkins shown in FIG. 6F. The present invention provides the flameless taper candle covered with the attractive wax sleeve, and also provides an easily manufactured method to make the wax sleeves having beautiful modeling. The wax sleeve is coated with wax, which also makes the flameless taper candle being almost real and provides variable appearances with attraction.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A flameless taper candle, comprising:
an elongated portion having an upper tubular body and a PCB, said upper tubular body being taper-shaped and having a top portion and an end portion, said PCB having a flicker IC and assembled in said upper tubular body;
a light portion having a lamp and a lampshade, said lamp electrically connecting with said PCB and being exposed outside said top portion of said upper tubular body, said lampshade fixed on said top portion of said upper tubular body and covering said lamp;
a power portion having a lower tubular body and at least one rechargeable battery, said lower tubular body being taper-shaped having a top portion and an end portion; said top portion of said lower tubular body removably secured to said end portion of said upper tubular body, said at least one rechargeable battery disposed in said lower tubular body and electrically connecting with said PCB;
a wax sleeve having an inner shell and a wax layer coated on said inner shell, and defining a taper-shaped cavity for receiving said upper tubular body and said lower tubular body; and
a switch portion removably secured on said end portion of said lower tubular body for interrupting or connecting said rechargeable battery to said PCB, and having a recharge jack mounted therein.

2. The flameless taper candle as in claim 1, wherein said lamp is a LED (Light Emitting Diode).

3. The flameless taper candle as in claim 1, wherein said PCB further comprises a photocell IC for controlling light automatically at night.

4. The flameless taper candle as in claim 1, wherein said PCB further comprises a timer IC for providing a time-control function and lighting in predetermined hours.

5. The flameless taper candle as in claim 1, wherein said lamp is soldered on a top of said PCB.

6. The flameless taper candle as in claim 1, wherein said top portion of said upper tubular body is formed with a female thread portion, and said lampshade is formed with a male thread portion for securing with said female thread portion of said upper tubular body.

7. The flameless taper candle as in claim 1, further comprising a fixing element mounted in said upper tubular body for fixing said PCB.

8. The flameless taper candle as in claim 1, wherein said lower tubular body has a conductive rivet fixed on said top portion thereof, and a conductive lead fixed on an inner surface thereof, said conductive rivet electrically connecting with said PCB and a positive electrode of said rechargeable battery, said conductive lead electrically connecting with said PCB and said switch portion.

9. The flameless taper candle as in claim 1, wherein said switch portion has an insulative cap, a metal plate, and a spring, said insulative cap formed with a cavity for receiving said metal plate, said spring fixed on said metal plate and electrically connecting with a positive electrode of said rechargeable battery.

10. The flameless taper candle as in claim 9, further comprising a bottom jacket covering a periphery of said insulative cap, said bottom jacket having a plurality of flexible ribs extending outwardly from a periphery thereof, thereby said flameless taper candle is able to adapt to different sizes of holders.

11. The flameless taper candle as in claim 1, wherein said bottom jacket formed with a plugging hole in a central bottom portion thereof for receiving a recharge plug.

12. The flameless taper candle as in claim 1, wherein said inner shell is made of plastic.

13. The flameless taper candle as in claim 12, wherein said inner shell is made of vinyl plastic.

14. The flameless taper candle as in claim 13, wherein said inner shell is formed by a centrifugal casting molding technology.
